(19) United States
(12) Patent Application Publication
(10) Pub. No.: US 2017/0154637 A1
(43) Pub. Date: Jun. 1, 2017

(54) COMMUNICATION PATTERN MONITORING AND BEHAVIORAL CUES

(71) Applicant: INTERNATIONAL BUSINESS MACHINES CORPORATION, Armonk, NY (US)

(72) Inventors: JEAN CHU, ENGLEWOOD CLIFFS, NJ (US); SUSAN L. DIAMOND, POUGHKEEPSIE, NY (US); OIZA V. DORGU, MISSOURI CITY, TX (US); WILLIAM FANG, ASTORIA, NY (US); PETER B. HOM, OAKLAND GARDENS, NY (US); JENNY S. LI, DANBURY, CT (US); JEREMY TIO, MARKHAM (CA); JING-NA YUAN, HOPEWELL JUNCTION, NY (US)

(21) Appl. No.: 14/953,352

(22) Filed: Nov. 29, 2015

(51) Int. Cl. G10L 25/48; G10L 21/034; G10L 15/18

(52) U.S. Cl. CPC G10L 25/48; G10L 15/18; G10L 21/034

(57) ABSTRACT

Embodiments include method, systems and computer program products for monitoring communication patterns and performing behavioral cues. Aspects include determining a relationship model for a conversation, wherein the relationship model includes one or more speech behavior rules. Aspects also include receiving and analyzing an audio of the conversation and based on a determination that one or more of the speech behavior rules are being violated, generating a passive alert to a participant in the conversation that has violated one of the speech behavior rules to prompt a change a behavior of the participant. Based on a determination that the behavior of the participant has not improved in a time period since the passive alert, aspects include performing an active intervention in the conversation.

### BACKGROUND

The present disclosure relates generally to analysis of communication patterns, and more specifically, to methods, systems and computer program products for monitoring communication patterns and performing behavioral cues.

Good communication practices are important for every successful personal or business relationship. However, individuals may not be always able to achieve productive and smooth conversation due to various factors including sentiments and predisposition of parties involved. Some examples include, individuals getting frustrated that they were constantly interrupted in during a conversation, or the other party dominated the conversation without any opportunity for them to express their ideas.

For various, perhaps non-intentional, reasons conversations may end with one or more participants feeling frustrated or having hurtful feelings. Often times the problem lies in the lack of self-awareness of poor communication behaviors of one or more participants of the conversation. Without an effective mediation tool to help to achieve an effective communication or conversation goal, annoyance, conflicts, frustration and even hurtful feelings will continue to escalate.

### SUMMARY

In accordance with an embodiment, a method for monitoring communication patterns and performing behavioral cues is provided. The method includes determining a relationship model for a conversation, wherein the relationship model includes one or more speech behavior rules, and receiving and analyzing an audio of the conversation by a processing system. Based on a determination that one or more of the speech behavior rules are being violated, the method includes generating a passive alert to a participant in the conversation that has violated one of the speech behavior rules to prompt a change a behavior of the participant. Based on a determination that the behavior of the participant has not improved in a time period since the passive alert, the method also includes performing an active intervention in the conversation.

In accordance with another embodiment, a processing system for monitoring communication patterns and performing behavioral cues includes a processor in communication with one or more types of memory. The processor is configured to determine a relationship model for a conversation, wherein the relationship model includes one or more speech behavior rules, and to receive and analyze an audio of the conversation. Based on a determination that one or more of the speech behavior rules are being violated, the processor is also configured to generate a passive alert to a participant in the conversation that has violated one of the speech behavior rules to prompt a change a behavior of the participant. Based on a determination that the behavior of the participant has not improved in a time period since the passive alert, the processor is further configured to perform an active intervention in the conversation.

In accordance with a further embodiment, a computer program product for monitoring communication patterns and performing behavioral cues includes a non-transitory storage medium readable by a processing circuit and storing instructions for execution by the processing circuit for performing a method. The method includes determining a relationship model for a conversation, wherein the relationship model includes one or more speech behavior rules, and receiving and analyzing an audio of the conversation. Based on a determination that one or more of the speech behavior rules are being violated, the method includes generating a passive alert to a participant in the conversation that has violated one of the speech behavior rules to prompt a change a behavior of the participant. Based on a determination that the behavior of the participant has not improved in a time period since the passive alert, the method also includes performing an active intervention in the conversation.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a block diagram illustrating one example of a processing system for practice of the teachings herein;

FIG. 2 is a block diagram illustrating a user device for monitoring communication patterns and performing behavioral cues in accordance with an exemplary embodiment;

FIG. 3 is a block diagram illustrating system for monitoring communication patterns and performing behavioral cues in accordance with an exemplary embodiment; and

FIG. 4 is a flow diagram illustrating a method for monitoring communication patterns and performing behavioral cues in accordance with an exemplary embodiment.

### DETAILED DESCRIPTION

In accordance with exemplary embodiments of the disclosure, methods, systems and computer program products for monitoring communication patterns and performing behavioral cues are provided. In exemplary embodiments, the system is configured to improve the effectiveness of personal communication between individuals by increasing an individual's awareness of their speech patterns and behaviors. In one embodiment, this information can be used to improve the effectiveness of a conversation by preventing someone from dominating the conversation. In exemplary embodiments, a speech analysis system monitors communication behaviors during a conversation and gives feedback to a user for guidance and self-awareness. The speech analysis system can be embedded in a mobile phone or a wearable device or it may be part of conference call system. The communication behaviors monitored can include an amount of time each party speaks, a frequency of interruptions, a number of mantras, and a range of pitch that may indicate out-of-bound emotions. In exemplary embodiments, the speech analysis system includes a set of communications rules and goals that can be set by the user or by a third party. The speech analysis system monitors the speech behavior of a user during a conversation and provides guidance to a user when a rule is violated or a threshold is exceeded to raise awareness for behavior cues. The guidance provided to the user can include an audio alert, a physical alert, or a visual alert. In addition, the speech analysis system can accumulate and analyze the data of past conversations, and show the statistics and progress of communication behaviors.

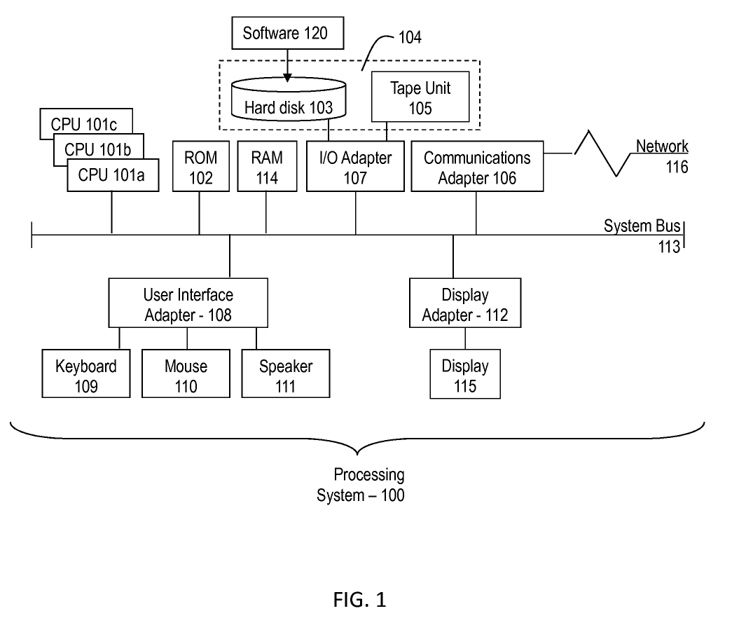

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Software 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

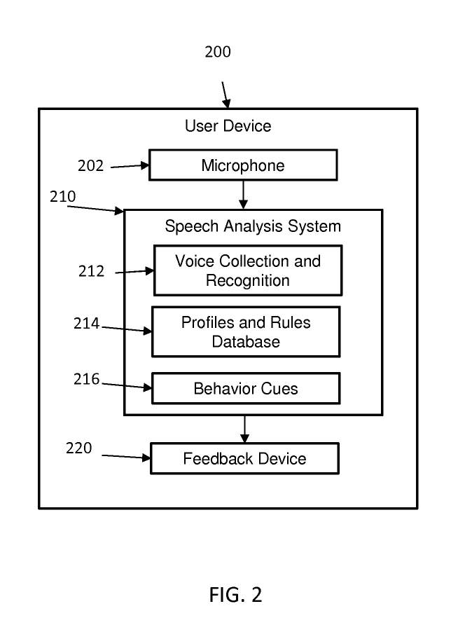

Referring now to FIG. 2, a block diagram of a user device 200 for monitoring communication patterns and performing behavioral cues is shown. In exemplary embodiments, the user device 200 may be embodied in a smartphone, a processing system (similar to the one shown in FIG. 1), a smartwatch, or any other suitable device that includes a processor and memory. The user device 200 includes a microphone 202, a speech analysis system 210 and a feedback device 220. In exemplary embodiments, the user device 200 receives audio input for a conversation from the microphone 202. The audio input is provided to the speech analysis system 210 which compares the speech behaviors to one or more rules or goals and responsively instructs a feedback device 220 to alert a user to modify their speech behavior.

In exemplary embodiments, the speech analysis system 210 includes a voice collection and recognition module 212 that is configured to receive the audio signal from the microphone 202 and to perform audio processing on the audio signal. The voice collection and recognition module 212 can identify different voices of the individuals in the audio signal and can analyze the speech behavior of each of the different individuals. The speech behavior can include an amount of time each party speaks, a frequency of interruptions, a number of mantras, and a range of pitch that may indicate out-of-bound emotions. In exemplary embodiments, the voice collection and recognition module 212 can accumulate and analyze the data of conversations and can output statistics of the communication behavior. The voice collection and recognition module 212 can also be used to track the progress of communication behaviors, i.e., is an individual's communication behavior improving over time.

The speech analysis system 210 also includes a profile and rule database 214 that is configured to store one or more speech behavior rules and thresholds that can be used to trigger the generation of an alert. In exemplary embodiments, the or more speech behavior rules and thresholds can be part of a relationship model that are communication profiles that allows a user to create objectives for a conversations or a meeting using speech behavior rules. Exemplary speech behavior rules may include, but are not limited to, the maximum duration a participant can speak at a time, the maximum time one can remain silent, the maximum number of interruptions allowed, the maximum number of mantras, or disruptive phrases, allowed (as used herein a mantra is a used to refer to a disruptive phrase or idioms), the maximum number and duration of conversations with emotions out-of-bound, where emotional out-of-bound being determined via quantitative metrics such as disruptive phrases, vocal volume, interruptions.

The speech analysis system 210 also includes a behavior cues module 216 that is configured to store one or more behavioral cue alerts that the user device 200 is capable of providing and an association between each of the speech behavior rules and the one or more behavioral cue alerts. For example, each speech behavior rule can also be associated with either a passive alert or an active intervention that can be selected based on the capabilities of a feedback device 220 of the user device 200. For example, the feedback device 220 may include a speaker, a visual display device, a haptic feedback device or the like. In one embodiment, the type of feedback provided to the individual can be based on a combination of the available feedback devices 220 and upon the speech behavior rule/threshold violated. For example, a short tone may be played via a speaker to the individual if they exceed a first threshold and a louder/longer tone may be played via the speaker to the individual if they exceed a second threshold.

In exemplary embodiments, the alerts may include both active interventions and passive alerts, where a passive alert is a simple notification and an active intervention provides a suggested change in the user's behavior. For example, an active intervention can be selected if an individual exceeds a maximum number of interruptions and a passive alert can be used if an individual has too many mantras/disruptive phrases. Because the speech analysis system 210 serves is impartial, the participant(s) can adjust their speech behaviors without feeling like the observation of their behavior was prejudiced. This is an improvement over previous system because it gives a workable context for improving singular or group conversation dynamics due to the impartial nature of the system moderator and includes providing feedback to the participant(s) to adjust their speech patterns to meet the preset agreed upon parameters.

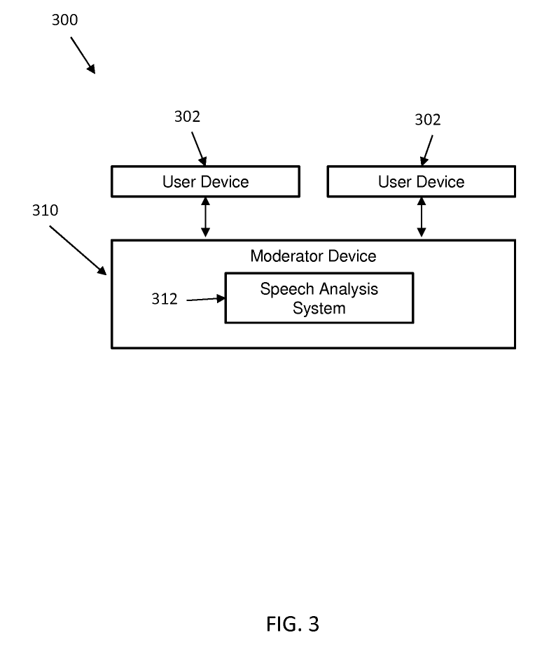

Referring now to FIG. 3, a block diagram of a system 300 for monitoring communication patterns and performing behavioral cues is shown. In exemplary embodiments, the system 300 includes multiple user devices 302, which may be similar to the user device shown in FIG. 2, and a moderator device 310 that is in communication with each of the multiple user devices 302. In exemplary embodiments, the moderator device 310 may include a speech analysis system 312 similar to the one described above with referenced to FIG. 2. In the system 300, the speech analysis system 312 may be configured to monitor conversations among multiple users that each have a user device 302 and to ensure that the user's communication behavior complies with one or more speech behavior rules that have been agreed to for a meeting or conversation. In exemplary embodiment, the speech analysis system 312 can be configured to instruct the user devices 302 to generate alerts to the individual users or it can be configured to generate its own alerts. In one embodiment, the speech analysis system 312 can also be configured to take actions to enforce speech behavior rules that are being violated.

In one example, two users connect to a conference call system that includes a moderator device 310 via separate user devices 302. The speech analysis system 312 monitors the conversation between the two users and can instruct the user devices 302 to generate alerts based on the violation of one or more speech behavior rules. In addition, if other speech behavior rules are violated, the speech analysis system 312 may take corrective action such as modifying a volume level of an individual's voice in the conference call, muting an individual's voice during the conference call, providing an audible suggestion to the participants of the conference call to modify their behavior. For example, the speech analysis system 312 may determine that the conversation has wondered off of the agreed topic and may provide an audible alert to return to the agreed topic. In another example, the speech analysis system 312 may determine that the conversation has become heated, or emotional, and may create an audible alert which suggests that the users take a break and resume their conversation at a later time.

In exemplary embodiments, the speech analysis system is configured to allow individuals to choose a relationship model that can be used for setting the speech behavior rules for a conversation. Such relationship models can then be automatically used for all conversations of a certain type. The relationship models can include business relationships, parent/child relationships, spouse-to-spouse relationships, teacher/students relationships, peer relationships, etc. The speech analysis system may have access to a contact database on the user device that can be used to make a determination of which relationship model should be used for each conversation.

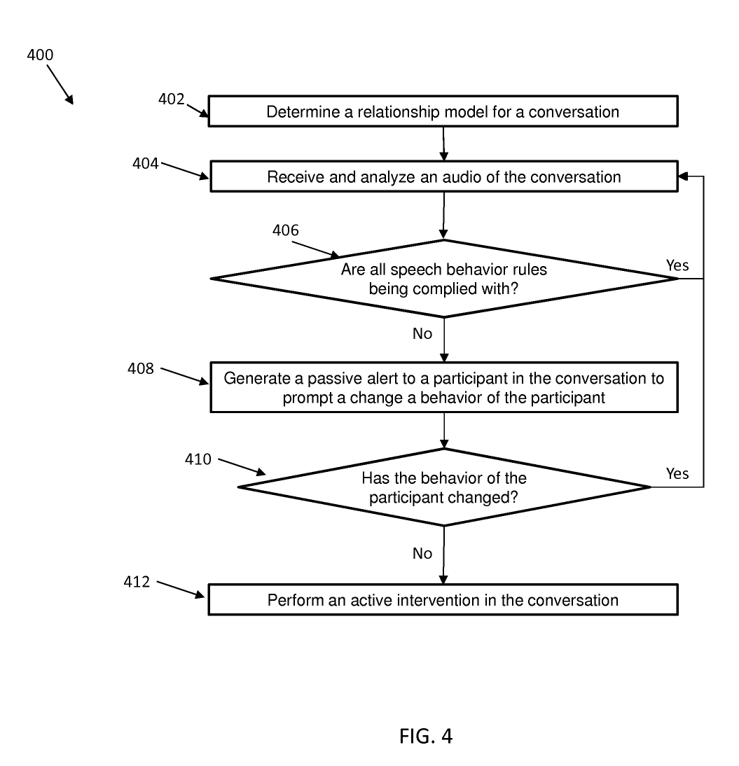

Referring now to FIG. 4, a flow chart illustrating a method 400 for monitoring communication patterns and performing behavioral cues in accordance with an exemplary embodiment is shown. As shown at block 402, the method 400 includes determining a relationship model for a conversation. In exemplary embodiments, the relationship model is determined based on the identity of the participants in the conversation and the relationship model includes one or more speech behavior rules for the conversation. Next, as shown at block 404, the method 400 includes receiving and analyzing an audio of the conversation. In exemplary embodiments, the analysis may include an analysis of the tone, word choice, speaking time, etc. of one or more participants in the conversation. As shown at decision block 406, the method 400 also includes determining if all of the speech behavior rules are being complied with. If all of the speech behavior rules are being complied with, the method 400 returns to block 404 and continues to monitor the conversation. If all of the speech behavior rules are not being complied with, the method proceeds to block 408 and generates a passive alert to a participant in the conversation to prompt a change a behavior of the participant. In exemplary embodiments, the passive alert is only provided to the participant in the conversation which has violated one of the speech behavior rules. The passive alert may be an audible signal, a visual indicator, a haptic feedback, or the like.

Continuing with reference to FIG. 4, as shown at decision block 410, the method 400 includes determining if the participant of the conversation that received the passive alert has changed their behavior to comply with the speech behavior rules. If the participant of the conversation has changed their behavior to comply with the speech behavior rules, the method 400 returns to block 404 and continues to monitor the conversation. Otherwise, the method 400 proceeds to block 412 and includes performing an active intervention in the conversation. In exemplary embodiments, the active intervention is an audible alert that is audible to all participants in the conversation. For example, the audible alert can be a suggestion to the participants in the conversation to alter a topic of the conversation. In exemplary embodiments, the active intervention can include altering an audio signal of the participant in the conversation that violated the one of the speech behavior rules. In one example, altering the audio signal of the participant in the conversation that violated the one of the speech behavior rules includes muting a voice of the participant in the conversation that violated the one of the speech behavior rules. In another example, altering the audio signal of the participant in the conversation that violated the one of the speech behavior rules includes changing a volume of a voice of the participant in the conversation that violated the one of the speech behavior rules.

In exemplary embodiments, the speech analysis system is configured to sense the sentiment or emotion of the participants in the conversation and it can mediate the conversation by directly addressing the speaker via visual clues or direct interruption to a conversation as mentioned before. The speech analysis system can also make recommendation on phrases or words to be used by other participants to remediate/ease the conversation, e.g., words to use to calm a person down, or words to use for a negotiation situation etc.

In exemplary embodiments, the speech behavior rules can include both rules and objectives for a conversation. The rules and objectives can be for individuals or can be group based. For example, a user may have a rule that they will only talk at most a certain percentage of the time, that they will not raise their voice above a predetermined level, or that they will not use one or more specific words. The rules and objectives can be set by individuals or by a meeting chair. For example, a user may set an objective to improve his or her own speech in a group meeting by eliminating sounds such as “hm”, “ya”, “ah” etc. In another example, a meeting chair may set an objective to make sure each meeting attendee voice his or her opinion in a meeting.

In exemplary embodiments, historical data of previous meeting details can be saved for trend analysis. Meeting details may include and not limited to names of meeting participants, meeting discussion topics, speech behavior rules and objectives, number of passive interrupts and active interrupts generated by the moderator device 310, etc. Such historical data can be used to analyze the effectiveness of group communications or trends of individuals' communication behaviors for future improvements.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for monitoring communication patterns and performing behavioral cues, the method comprising:
determining a relationship model for a conversation, wherein the relationship model comprises one or more speech behavior rules and wherein the relationship model is determined based on a relationship of participants in the conversation;
receiving and analyzing an audio of the conversation by a speech analysis system of a conference calling system that determines whether one or more of the speech behavior rules are being violated by analyzing a speech behavior of the participants in the conversation, wherein the speech behavior includes an amount of the participants speaks, a frequency of interruptions, a number of mantras, and a range of pitch that indicates out-of-bound emotions;
based on a determination that one or more of the speech behavior rules are being violated, generating a passive alert to a participant in the conversation that has violated one of the speech behavior rules to prompt a change a behavior of the participant;
based on a determination that the behavior of the participant has not improved in a time period since the passive alert, performing an active intervention in the conversation, wherein the active intervention is an audible alert that is audible to all participants in the conversation and wherein the audible alert is a suggestion to the participants in the conversation to alter a topic of the conversation;
collecting data regarding compliance with the speech behavior rules by each of the participants in the conversation; and
analyzing the collected data and outputting statistics of the compliance with the speech behavior rules by each of the participants in the conversation.

2. The computer-implemented method of claim 1, wherein the passive alert is one of an audible alert, a visual alert or a physical alert that is only presented to the participant in the conversation that violated the one of the speech behavior rules.

3. (canceled)

4. (canceled)

5. The computer-implemented method of claim 1, wherein the active intervention includes altering an audio signal of the participant in the conversation that violated the one of the speech behavior rules.

6. The computer-implemented method of claim 5, wherein altering the audio signal of the participant in the conversation that violated the one of the speech behavior rules includes muting a voice of the participant in the conversation that violated the one of the speech behavior rules.

7. The computer-implemented method of claim 5, wherein altering the audio signal of the participant in the conversation that violated the one of the speech behavior rules includes changing an volume of a voice of the participant in the conversation that violated the one of the speech behavior rules.

8. A computer program product for monitoring communication patterns and performing behavioral cues, the computer program product comprising:
a non-transitory storage medium readable by a processing circuit and storing instructions for execution by the processing circuit for performing a method comprising:
determining a relationship model for a conversation, wherein the relationship model comprises one or more speech behavior rules and wherein the relationship model is determined based on a relationship of participants in the conversation;
receiving and analyzing an audio of the conversation to determine whether one or more of the speech behavior rules are being violated by analyzing a speech behavior of the participants in the conversation, wherein the speech behavior includes an amount of the participants speaks, a frequency of interruptions, a number of mantras, and a range of pitch that indicates out-of-bound emotions;
based on a determination that one or more of the speech behavior rules are being violated, generating a passive alert to a participant in the conversation that has violated one of the speech behavior rules to prompt a change a behavior of the participant;
based on a determination that the behavior of the participant has not improved in a time period since the passive alert, performing an active intervention in the conversation, wherein the active intervention is an audible alert that is audible to all participants in the conversation and wherein the audible alert is a suggestion to the participants in the conversation to alter a topic of the conversation;
collecting data regarding compliance with the speech behavior rules by each of the participants in the conversation; and
analyzing the collected data and outputting statistics of the compliance with the speech behavior rules by each of the participants in the conversation.

9. The computer program product of claim 8, wherein the passive alert is one of an audible alert, a visual alert or a physical alert that is only presented to the participant in the conversation that violated the one of the speech behavior rules.

10. (canceled)

11. (canceled)

12. The computer program product of claim 8, wherein the active intervention includes altering an audio signal of the participant in the conversation that violated the one of the speech behavior rules.

13. The computer program product of claim 12, wherein altering the audio signal of the participant in the conversation that violated the one of the speech behavior rules includes muting a voice of the participant in the conversation that violated the one of the speech behavior rules.

14. The computer program product of claim 12, wherein altering the audio signal of the participant in the conversation that violated the one of the speech behavior rules includes changing an volume of a voice of the participant in the conversation that violated the one of the speech behavior rules.

15. A processing system for monitoring communication patterns and performing behavioral cues, comprising:
a processor in communication with one or more types of memory, the processor configured to:
determine a relationship model for a conversation, wherein the relationship model comprises one or more speech behavior rules and wherein the relationship model is determined based on a relationship of participants in the conversation;
receive and analyze an audio of the conversation to determine whether one or more of the speech behavior rules are being violated by analyzing a speech behavior of the participants in the conversation, wherein the speech behavior includes an amount of the participants speaks, a frequency of interruptions, a number of mantras, and a range of pitch that indicates out-of-bound emotions;
based on a determination that one or more of the speech behavior rules are being violated, generate a passive alert to a participant in the conversation that has violated one of the speech behavior rules to prompt a change a behavior of the participant; and
based on a determination that the behavior of the participant has not improved in a time period since the passive alert, perform an active intervention in the conversation, wherein the active intervention is an audible alert that is audible to all participants in the conversation and wherein the audible alert is a suggestion to the participants in the conversation to alter a topic of the conversation;
collect data regarding compliance with the speech behavior rules by each of the participants in the conversation; and
analyze the collected data and output statistics of the compliance with the speech behavior rules by each of the participants in the conversation.

16. The processing system of claim 15, wherein the active intervention is an audible alert that is audible to all participants in the conversation.

17. (canceled)

18. The processing system of claim 15, wherein the active intervention includes altering an audio signal of the participant in the conversation that violated the one of the speech behavior rules.

19. The processing system of claim 18, wherein altering the audio signal of the participant in the conversation that violated the one of the speech behavior rules includes muting a voice of the participant in the conversation that violated the one of the speech behavior rules.

20. The processing system of claim 18, wherein altering the audio signal of the participant in the conversation that violated the one of the speech behavior rules includes changing a volume of a voice of the participant in the conversation that violated the one of the speech behavior rules.
